(19) United States
(12) Patent Application Publication
(10) Pub. No.: US 2003/0229848 A1
(43) Pub. Date: Dec. 11, 2003

(54) Table filtering in a computer user interface

(76) Inventors: Udo Arend, Heidelberg (DE); Edmund Eberleh, St. Leon-Rot (DE); Heinz Willumeit, Leimen (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/233,085

(22) Filed: Aug. 30, 2002

Related U.S. Application Data
(60) Provisional application No. 60/386,400, filed on Jun. 5, 2002.

(51) Int. Cl. G06F 17/00

(52) U.S. Cl. 715/509; 715/510; 715/507

(57) ABSTRACT

Techniques are disclosed for displaying information to a user on a display device of a computer system. In one general aspect, the invention provides for the display of a first view having a plurality of objects in a table of rows and columns on the display device. Each object is displayed as a row in the table and has a plurality of fields, where each field is in a column of the table. A blank input row corresponding to the table is displayed, having input fields corresponding to the columns of the table. An input is received in the form of a character string in a selected input field of the input row. A filter command is received, causing a filtering function to be performed on a field of the objects corresponding to the selected input field of the input row using the character string, and filtered data is displayed.

### CROSS REFERENCE TO RELATED APPLICATIONS

This application claims priority from U.S. Provisional Application No. 60/386,400, filed Jun. 5, 2002, and titled “User Interface with Object Task Area,” which is incorporated by reference in its entirety.

### TECHNICAL FIELD

The invention relates to computer user interfaces, and more particularly to the filtering of data for display in a table.

### BACKGROUND

A table having rows and columns may be displayed on a computer display device. Data pertaining to a specific topic may be displayed in the table, for example, with database objects, or records, in different rows of the table and selected fields for objects in columns. Tables may contain a small number of database objects (for example, less than five), or a very large number (hundreds, thousands, or more). As such, a method to isolate and display particular objects of interest to a user becomes especially desirable when dealing with large tables.

Table filtering is a function that, at the direction of a user interface program, identifies those objects in a table that satisfy one or more conditions for one or more table fields, and then exclusively displays the desired objects. For example, a user may select a pull-down menu option from a menu bar, and a pop-up window may open on the display where the user may specify a filter condition(s) for filtering a table of objects. In another example, a filtering function may be initiated by a user who selects a button from a toolbar, and then specifies the desired filter condition(s) in a filter window that pops up on the display. Under either example, when the filter window appears on the display, it may obscure the user's view of some or all of the table. In some cases, the filter window may be dragged to another area of the screen; in other cases it may not.

As another example, the display may initially have one or more separately displayed filter fields, located either above or below the table, where a user may enter a filter condition. If only a single filter field, or a few fields, are made available, the user may not be able to filter the table on the desired field. If a large number of filter fields are made available, the amount of display space consumed by separately listing each field may be considerable, leaving less space for other work areas. There is therefore a need for an interface that allows for easy filtering of tables of data.

### SUMMARY

The invention provides techniques for displaying information to a user on a display device of a computer system. In one general aspect, the invention provides for the display of a first view having a plurality of objects in a table of rows and columns on the display device. Each object is displayed as a row in the table and has a plurality of fields, where each field is in a column of the table. A blank input row corresponding to the table is displayed, having input fields corresponding to the columns of the table. An input is received in the form of a character string in a selected input field of the input row. A filter command is received, causing a filtering function to be performed on a field of the objects corresponding to the selected input field of the input row using the character string, and filtered data is displayed.

The input row may be the first row of the table, may be a filter row, and may have an input field for each column of the table. Additionally, the input row may be associated with a computer application, and may be displayed each time the computer application is executed. The filter command may be a carriage return, a provision of data followed by a predetermined period of inactivity, or the selection of a filter button. In this case, the filter button may be located in the input row.

In some embodiments, the objects may be database objects. A third view may be displayed that may include a subset of objects, specified by the filtering function, from the plurality of objects. In this case, the third view may display, from the objects displayed in the first view, only those objects contained in the subset of objects. The filtering function may specify the subset of objects by comparing the character string in the selected input field of the input row with the entry in the corresponding field for each of the objects in the plurality of objects. The subset of objects may be arranged in a filtered table of rows and columns with one object per row, and the input row may be displayed with the filtered table. A subsequent filtering function may be performed on the filtered table. The third view may contain a notification message that a filtering function has been performed. The objects may be local to a computer system.

The character string may include an operator. In this case, the operator may be selected from a group of operators consisting of “logical or”, “greater than”, “less than”, “not equal”, range indicator, and wild card indicator. Before receiving the filter command, input may be received in the form of a plurality of filter conditions, with each filter condition including a character string and a corresponding selected field of the input row. In this case a logical “AND” relation, or alternatively, a logical “OR” relation, may be applied to the filter conditions.

Advantages of the invention may include one or more of the following. A new level of data table filtering convenience is possible. For example, a table of data incorporating the invention is, in some respects, more flexible, and as such, may be suitable for applications where a table of data lacking the invention would be unsuitable. A blank input row, immediately visible, ready for input, and corresponding to a table of data, is presented on a user interface display screen, allowing the table of data to be filtered using an entered filter condition. In some cases, eliminating the need to select or enable a filtering option prior to the display of a filter mechanism results in an easier-to-use interface. The input row's compact representation, comprehensive coverage, and proximity to the table provide a convenient and practical filter mechanism, without consuming undue display space. Because the input row continues to display the filter condition after filtering, the filtered data may be directly associated with the condition.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of a system that may utilize aspects of the invention;

FIGS. 2-3 are screen snapshots of a computer display in accordance with an embodiment of the invention; and

FIG. 4 is a flowchart illustrating an example of how the user interface software application shown in FIG. 1 may operate to produce the displays shown in FIGS. 2-3.

Like reference symbols in the various drawings indicate like elements.

### DETAILED DESCRIPTION

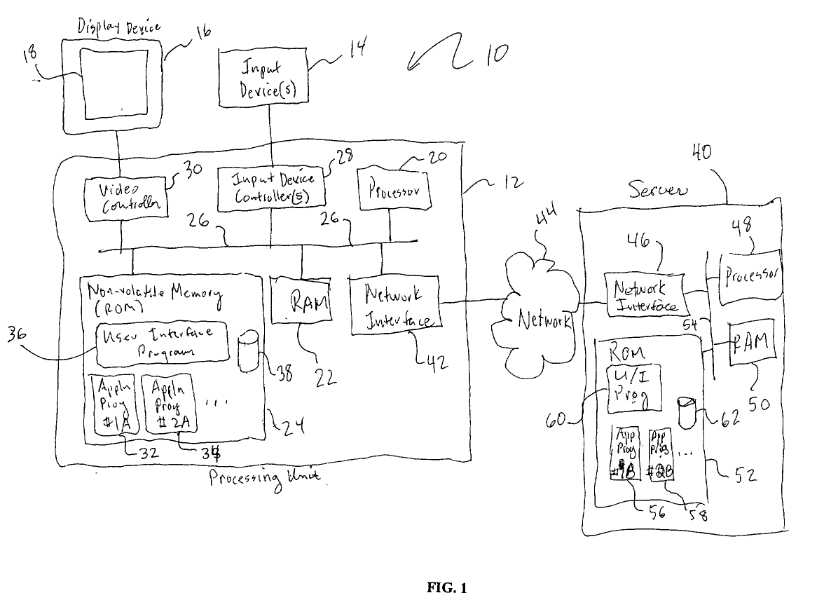

A computer system 10, shown in FIG. 1, includes a processing unit 12, one or more input devices 14, and a display device 16 upon which a user is presented displays in accordance with the invention. The display device 16 has a video screen 18 upon which displays appear.

As is conventional, the processing unit 12 includes a processor 20, random access memory (RAM) 22, and read-only memory (ROM) 24, all interconnected by a data bus 26. Input device controllers 28, also connected to the data bus 26, receive command signals from input devices 14 and forward the command signals in the appropriate format for processing. A video controller 30, connected to the data bus 26, receives video command signals from the data bus 26 and generates the appropriate video signals that are forwarded to the display device 16 so that the desired display is provided on the screen 18. The computer system 10 is not limited to a personal computer, but could instead include a personal digital assistant, a terminal, a workstation, or other such device.

ROM 24, as is conventional, provides non-volatile data storage for various application programs. In the example shown in FIG. 1, a number of different application programs 32, 34, etc., are stored in ROM 24. Also stored in ROM 24 is a user interface program 36 designed to work in concert with each of the application programs 32, 34, etc. This is conceptually depicted in FIG. 1 by the user interface program 36 being shown as a layer on top of the application programs 32, 34, etc. With such a design, user interface program modules common to several application programs need not be duplicated in each of the application programs. In addition, such a design may enable a common “look-and-feel” to the user interface for the different program applications 32, 34, etc. In other implementations, the user interface program, or module, need not be a common program or module for more than one program application. Also, the components just described could be combined or separated in various manners, and could be stored in various manners, such as on various non-volatile storage medium.

As is conventional, programs 32, 34, and 36 have program instructions that may be loaded into RAM 22 during operation. Processor 20 then executes the program instructions, as required, to perform desired program functions.

Also stored in ROM 24 are various data in database 38. Database 38 includes data needed or generated during operation of the application programs 32, 34, etc. In the FIG. 1 implementation, a single database 38 is shown that serves as a common database for all applications 32, 34, etc. In other implementations, there may be separate databases for one, or more, of the applications 32, 34, etc.

Also shown in FIG. 1 is server 40. The computer system 10 has a network interface 42, connected to its data bus 26. As such, computer system 10 may access server 40 via network 44 to run applications residing on the server 40. Network 44 may be, for example, a LAN, WAN, or the Internet. As is conventional, the server 40 includes a network interface 46, a processor 48, RAM 50, and ROM 52, all interconnected by a data bus 54. The server's network interface 46 provides the connection to network 44 so that client computer systems, such as system 10, can access the server 40. In similar fashion to computer system 10, the server ROM 52 includes various different application programs 56, 58, etc., as well as a common user interface program 60 for the application programs 56, 58, etc. ROM 52, in this example, also includes data stored in database 62, although in other implementations separate databases or a separate database server may be required.

The invention will be described in the context of a program application for customer relationship management (CRM). A CRM program application manages the interactions a company may have with its customers, for example, marketing, sales, and service functions. In one implementation, the CRM application program is made up of several different application program modules, some of which reside on a client computer, such as system 10, while others reside on a central server, such as server 40. CRM functions typically require access to, and generate, a large amount of data that is stored in various databases on a client or server. The data can include customer and product information, marketing statistics, and service information, to give just a few examples.

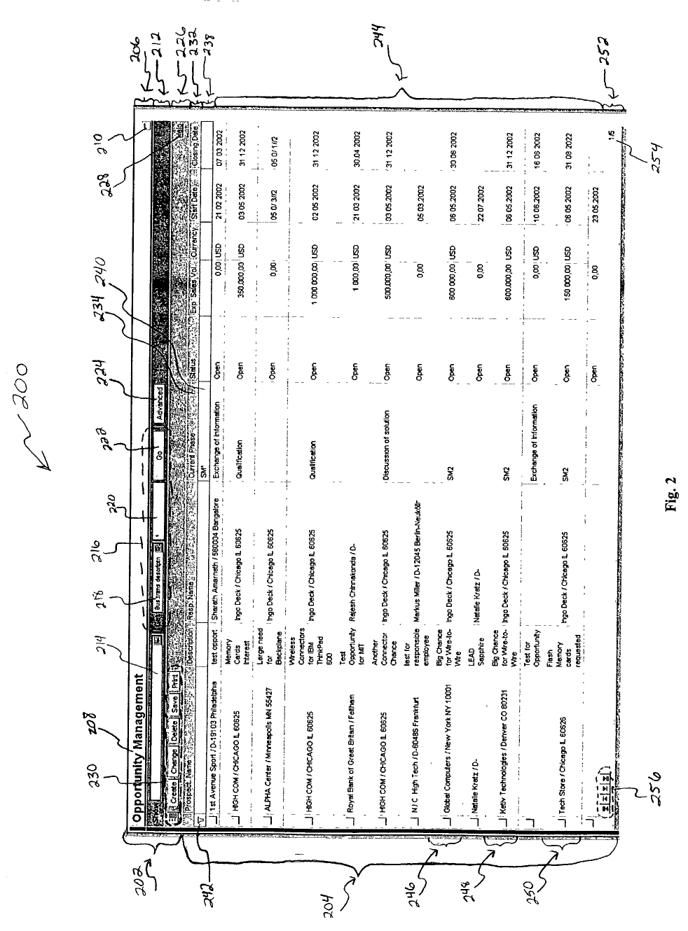

FIG. 2 shows an example display 200 that may be presented, on screen 18 shown in FIG. 1, to a user of a CRM application program. In this example, the user is using the program to review information on potential customers, by identifying business leads that are at a particular phase or stage in the new customer recruitment process. The business leads might originally have been obtained through contact with potential customers at a trade show, through sales pitches given by the user or a co-worker at a potential customer's site, or by potential customer inquiries received via the company's web site, to list just a few possibilities.

For discussion purposes, the display 200 may be divided into two areas, a top area 202, and a bottom area 204, located below the top area 202. Generally, the top area 202 allows the user to define and select search criteria for purposes of searching a database, such as database 62 (FIG. 1), for objects that may be presented to the user following the execution of the database search. An object is a collection of data, organized as a group of fields, where each field may contain a data entry that provides information pertaining to the object. Objects may be stored in a database, such as database 62, for access by users via networked computer systems, such as computer system 10. In this example, the objects represent potential business opportunities for the user's company. The bottom area 204 provides an area where the objects, identified using search criteria defined in the top area 202, are presented to the user. The user may work with one or more objects in this area 204, including performing specific tasks or functions that utilize the object information.

Beginning with the top area 202, a title row 206 is located along an upper edge of the top area 202. The title row 206 contains a display title 208 (“Opportunity Management” in this example) near its left side, and a minimization button 210 near its right side that a user may select to minimize the display area 200. In this example, the user knows he or she is viewing potential business opportunities in this display 200 because of the display title 208 (“Opportunity Management”).

A search bar 212, located below the title row 206, provides database search mechanisms that a user may use to search for, and identify, objects stored in the database 62. A first search mechanism 214, located near the left side of the search bar 212, is a “Show” mechanism containing a list with a selection of predefined searches allowing a user to retrieve collections of objects using previously-defined search patterns. A second search mechanism 216, positioned to the right of the “Show” mechanism 214, is a search tool having three parts: 1) a “Get” list 218 for selecting a field label, 2) a string entry field 220 for providing a search string, and 3) a “Go” button 222 for initiating the search. After choosing a field label from the “Get” list 218 and providing a search string in the search field 220, a user may select the “Go” button 222 to initiate a database search for objects having the entered search string in the selected field. A third mechanism 224 is an “Advanced” search button, positioned to the right of the “Go” button 222, which allows a user to define advanced search criteria for searching the database 62. This is the mechanism that the user would use if neither the first nor the second search mechanisms 214, 216 met the user's needs.

In the FIG. 2 example, a user has selected an object field label called “Bus. trans. descriptn” from the “Get” list 218, and has entered a wild card asterisk character “*” in the string entry field 220. The wild card character permits any combination of characters in the correspondingly selected field to satisfy the search criterion. After selecting the “Go” button 222, a database search executes (for example, on database 62) and the user is presented with all of the business objects having a “Bus. trans. descriptn” field from database 62. These objects are displayed in the bottom area 204 and will be discussed below.

Moving to the next row in the top display area 202, there is a toolbar 226. The toolbar 226 is a row below the search bar 212 and contains a “Help” icon 228 near its right side and a group of action buttons 230 near its left side. The “Help” icon 228, as is conventional, provides the user with assistance when selected. The group of action buttons 230, when selected, cause actions to occur that affect the bottom display area 204. Examples of such actions include, for example, displaying a selected object's detailed information, creating a new object, making changes to an object, deleting an object, saving changes made to an object, and printing an object's information. The toolbar 226 may contain other (including a different number of) buttons in other embodiments.

The bottom area 204 of display 200 contains a column label row 232, an input row 238, a table 244 of business objects, and an information row 252. The column label row 232, located along the top of area 204, provides labels identifying field names for each of the columns in the table 244. In this example, the column label of interest is the fourth column label, “Current Phase” 234, which indicates the phase of recruitment for a potential customer. The other column labels in the row of column labels 232 are “Prospect: Name,” the name of the potential customer; “Description,” a note section describing the opportunity; “Resp. Name,” the person within the user's company responsible for this business opportunity; “Status,” whether the matter is open or closed; “Exp. Sales Vol.,” the expected eventual sales volume; “Currency,” the relevant currency; “Start Date,” the date contact was initiated (format DD.MM.YYYY) with the potential customer; and “Closing Date,” the date the matter is expected to be closed.

The table 244 in FIG. 2 contains a collection of business objects, where each business object is displayed as a row in the table 244. The table 244 is located below an input row 238 (to be described later), and in this example, thirteen business objects are shown (although, as will be described later, table 244 consists of five pages with only the first page shown in FIG. 2). The columns of the table 244 correspond to the fields of the objects, identified by the respective label in the row of column labels 232. The table 244 of business objects was created using objects identified by a database search initiated by one of the three search mechanisms from the search bar 212, described above (the search tool 216 in this example).

Each potential customer listed in the FIG. 2 table 244 is currently in one of several different phases, regarding the amount of progress that the user's business has made with the potential customer. The phase is listed in that object's “Current Phase” field. Suppose a user wishes to see only potential customers currently in one of several sales and marketing (SM) phases. These might indicate phases, for example, where the potential customer has shown an interest in the products offered by the user's company (SM1 phase), agreed to an in-house presentation and demonstration of the products (SM2 phase), or requested sample products (SM3 phase). Within the table 244 of objects, objects 246 (Global Computers), 248 (Ketiv Technologies), and 250 (Tech Store), the eighth, tenth, and twelfth objects in the table 244, respectively, are each in the SM2 phase, and they each have an “SM2” entry in their Current Phase field.

A blank input row 238, or filter row, is located immediately below the row of column labels 232 and above the table 244, is partitioned into input fields corresponding to the columns of the table 244. In the FIG. 2 display 200, a user has already entered an “SM*” input in input field 240 of the input row 238. Initially, the input row 232 is blank (having empty input fields), immediately visible, and ready for input. In other embodiments, the filter row 238 may be integrated within the table 244 of objects.

The filter row 238 contains a filter button 242, a button with a funnel icon, near its left edge. The filter row 238 allows a user to filter the table 244 of objects by sorting the objects according to one or more conditions, and displaying only those objects that satisfy the condition(s). This feature is useful to a user, for example, when only certain objects in the table 244 are of interest. The user enters the desired filter condition(s) in the appropriate input field(s) of the filter row 238. In the FIG. 2 example, input field 240 of the filter row 238, which corresponds to the “Current Phase” column, contains a filter condition “SM*.” This indicates that the user is interested in viewing only business objects having “Current Phase” entries beginning with “SM.” (Note that in FIG. 2 the filtering has not yet been executed, so the table 244 still shows objects where the “Current Phase” entry does not begin with “SM.”)

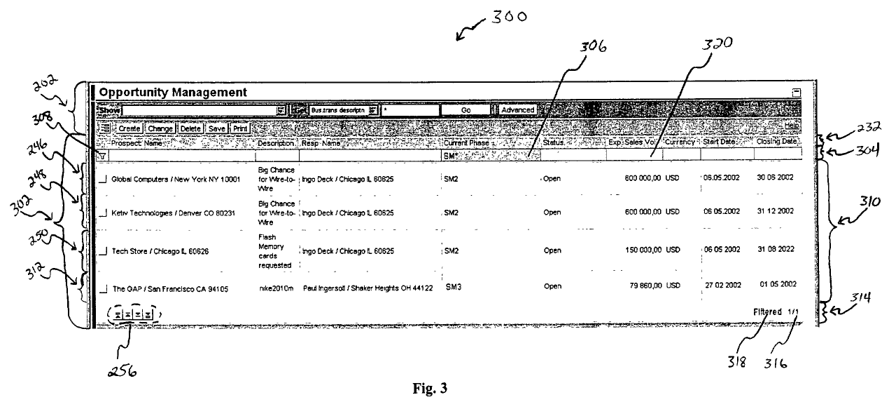

When the user selects the filter button 242, the table filtering function is initiated and will sort the table 244 of objects by identifying those objects that satisfy the filter condition(s) present in the filter row 238. In this example, the filtering function will identify all objects from the table 244 (including those objects on pages 2-5 not currently shown in FIG. 2) that are in one of the sales and marketing phases. The asterisk (“*”) is a wild card character, allowing any object having a “Current Phase” field entry beginning with “SM,” in this example, to satisfy the filter condition. FIG. 3 shows the resulting display 300, created by the user interface at the conclusion of the filtering operation, and will be described later.

Referring again to FIG. 2, an information row 252 for the table 244 of objects, located along the bottom of display area 204, contains a page number indicator 254 near its right side (page 1 of 5 in this example, indicating that there are five pages of business objects in table 244, and that page one is currently displayed). A group of buttons 256 for navigating between pages, for example by going backward or forward by one page, or by jumping to the first or last page, are located near the left side of the information row 252.

The FIG. 3 display 300 presents a filtered table 310 of business objects according to the “SM*” filter condition in the “Current Phase” input field 240 of the filter row 238 from FIG. 2, and comprises of a top area 202 and a bottom area 302. The top area 202 of display 300 is unchanged from the top area 202 of display 200 shown in FIG. 2, and is as described above in the discussion of FIG. 2.

The bottom display area 302 contains the unchanged row of column labels 232 from display 200 of FIG. 2, located here along the top of area 302. The row of column labels 232 is unchanged because the filtered table 310 still displays the same object fields as the unfiltered table 244 of FIG. 2, the difference being that only those objects having entries beginning with “SM” in the “Current Phase” field, in this example, are present in the filtered table 310. A filter row 304 is located below the row of column labels 232. A filter button 308, near the left side of the filter row 304, is highlighted to inform the user that the present table has been filtered. Also, the “Current Phase” input field 306, still containing the filter condition “SM*,” is highlighted to inform the user of the filter condition under which the filtering function executed.

The table 310 of filtered objects, located below the filter row 304, contains objects 246 (Global Computers), 248 (Ketiv Technologies), and 250 (Tech Store) from page one of the unfiltered table 244 shown in FIG. 2, as well as a new object 312 (The GAP). Object 312, the last object in the table 310 of filtered objects, was not displayed on page one of the unfiltered table 244 of FIG. 2, implying that it was originally located somewhere in pages 2-5 of the unfiltered table 244. Object 312 is in the “SM3” phase.

Thus it is seen that the filtering function works on all objects in the unfiltered table 244 originally identified by the database search specified by a search mechanism from the search bar 212 of FIG. 2. In this example, the filtering function operates on objects local to computer system 10, as the objects had previously been retrieved from database 62. Thus, additional database 62 accesses over network 44 are unnecessary.

The user now has, in display 300, access specifically to the objects of interest (those in a sales and marketing phase in this example), without having to try to locate them among all the other objects in the unfiltered table 244 of FIG. 2. The filter condition is clearly displayed in input field 306 of the filter row 304 in the present display 300, reminding the user of the relevant filter condition. Because the filter row 238 was adjacent to the table 244 in display 200 of FIG. 2, immediately visible and ready for input, the user did not have to hunt for and enable a filter option in a menu bar or toolbar, or deal with a new filter window appearing on the screen and potentially obscuring the table. Also, because of the compact representation of the filter row 238, display space on screen 18 is conserved and available for other work areas.

Referring again to FIG. 3, an information row 314 for the display area 300, located along the bottom of area 302, contains a page number indicator 316 (“1/1” in this example because the filtered table consists of a single page) near its right side, and the same group of buttons 256 from the FIG. 2 display 200 for navigating between pages near its left side. An icon 318 labeled “Filtered” also appears in the information row 314, to the left of the page number indicator 316. This provides another reminder to the user that what is presently displayed in display 300 is a filtered table from a previous display table.

Incremental filtering is also possible, by entering a new filter condition in the filter row 304 to further filter the filtered table 310. In this example, the filtered table 310 contains only four entries, but in other examples a filtered table may contain a large number of entries. Incremental filtering provides a simpler alternative for the user than having to initially formulate complex filter conditions. An incremental filtering function would operate on only those objects in the present (filtered) table. For example, if the user was specifically interested in those business objects from display 300 having an expected sales volume greater than $500,000, the user could enter the filter condition “>500.000,00” in the “Exp. Sales Vol.” input field 320 of the filter row 304. Then, after selecting the filter button 308, the filtering function would execute on the four objects 246, 248, 250, and 312 in the once-filtered table 310 to produce a new display having a twice-filtered table containing only objects 246 (Global Computers) and 248 (Ketiv Technologies), both of which have expected sales volumes of $600,000.

The example just described used the greater than operator as part of the filter condition. Other embodiments may permit additional operators to be used within filter conditions such as less than (“<”), not equal (“<>”), greater than or equal (“>=”), less than or equal (“<=”), logical ‘OR’ (“,”, “;”, “ ”), range operator (“-”, 1500-3000 for example), and wild card operator (“*”) etc.

Specifying multiple filter conditions within a filter row is also possible. When multiple filter conditions are specified, the filter condition used by the filtering function may be a logical ‘AND’ (relation requiring that each of the individual filter conditions be concurrently satisfied) of the individual filter conditions specified. For example, had the user additionally (along with the SM* condition previously discussed) specified the filter condition “>500.000,00” in the “Exp. Sales Vol.” input field of the filter row 238 in display 200 of FIG. 2, display 300 of FIG. 3 would simply have contained objects 246 (Global Computers) and 248 (Ketiv Technologies) in its filtered table. This provides flexibility, allowing the user to formulate complex filter conditions, if desired. Other Boolean operations may also be applied to the multiple filter conditions.

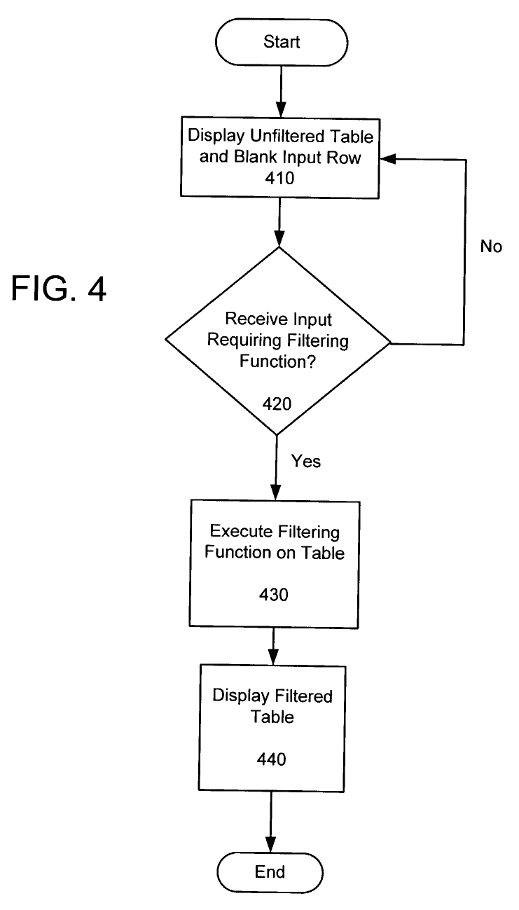

Referring to the flowchart of FIG. 4, the process performed by a processor executing instructions from a user interface program begins, at step 410, with the display of an unfiltered table and a blank input or filter row on screen 18 (FIG. 1). An example of an unfiltered table and filter row is shown in FIG. 2 (where the user has already entered the “SM*” filter condition in field 240 of the filter row, as previously described). Next, the receipt of an input requiring that a filtering function be performed, at step 420, prompts the execution of a filtering function on the table in step 430. In the absence of such a received input, the display with the unfiltered table and filter row will continue to be displayed (step 410). Examples of user inputs that may be received and necessitate the execution of a filtering function might include the click of a mouse button (for example, to select a filter button), the typing of a key or sequence of keys on the keyboard (a carriage return, for example), a predetermined period of inactivity after receiving data in an input field, a voice-activated command input, the touch of a touchpad screen, etc.

The filtering function executes by applying a specified filter condition or conditions to each of the objects in the unfiltered table of objects. To satisfy the filter condition(s), an object's field entry(s) must coincide with the entry(s) or expression(s) in the corresponding section(s) of the filter row. Those objects satisfying the filter condition(s) will form a subset of the original group of objects, and will subsequently be exclusively displayed in a filtered table.

Next, the resulting filtered table will be displayed at step 440 and the process ends. An example of a view with a filtered table is shown in FIG. 3.

A number of embodiments of the invention have been described. Nevertheless, it will be understood that various modifications may be made without departing from the spirit and scope of the invention. Accordingly, other embodiments are within the scope of the following claims.

What is claimed is:

1. A method of displaying information on a display device of a computer system, comprising:
displaying a first view on the display device, the first view comprising a plurality of objects in a table of rows and columns, each object displayed as a row in the table and comprised of a plurality of fields, each field being in a column of the table;
displaying a blank input row corresponding to the table, the input row having input fields corresponding to the columns of the table;
receiving an input in the form of a character string in a selected input field of the input row;
receiving a filter command; and
performing, in response to the filter command, a filtering function on a field of the objects corresponding to the selected input field of the input row using the character string, and displaying filtered data.

2. The method of claim 1 further comprising, displaying, on the display device, a third view that comprises a subset of objects, specified by the filtering function, from the plurality of objects.

3. The method of claim 2 wherein the third view comprises, from the objects displayed in the first view, only those objects contained in the subset of objects.

4. The method of claim 2 wherein the subset of objects is arranged in a filtered table of rows and columns with one object per row.

5. The method of claim 4 further comprising, displaying the input row with the filtered table.

6. The method of claim 5 further comprising, performing a subsequent filtering function on the filtered table.

7. The method of claim 2 wherein the third view contains a notification message that a filtering function has been performed.

8. The method of claim 1 wherein the input row is the first row of the table.

9. The method of claim 1 wherein the input row comprises a filter row.

10. The method of claim 1 wherein the objects are database objects.

11. The method of claim 1 wherein the filter command comprises a carriage return.

12. The method of claim 1 wherein the filter command comprises a selection of a filter button.

13. The method of claim 12 wherein the filter button is located in the input row.

14. The method of claim 1 wherein the filter command comprises the provision of data followed by a predetermined period of inactivity.

15. The method of claim 1 wherein the input row has an input field for each column of the table.

16. The method of claim 1 further comprising, receiving input in the form of a plurality of filter conditions, each filter condition comprised of a character string and a corresponding selected field of the input row, before receiving the filter command.

17. The method of claim 16 further comprising, applying a logical “AND” relation to the filter conditions.

18. The method of claim 16 further comprising, applying a logical “OR” relation to the filter conditions.

19. The method of claim 2 wherein the filtering function specifies the subset of objects by comparing the character string in the selected input field of the input row with the entry in the corresponding field for each of the objects in the plurality of objects.

20. The method of claim 1 wherein the character string comprises an operator.

21. The method of claim 20 wherein the operator is selected from a group consisting of “logical or”, “greater than”, “less than”, “not equal”, range indicator, and wild card indicator.

22. The method of claim 1 wherein the objects are local to a computer system.

23. The method of claim 1 wherein the input row is associated with a computer application, and is displayed each time the computer application is executed.

24. A graphical user interface for displaying items retrieved from a database, the user interface comprising:
a table having rows of a plurality of items, each row comprised of a plurality of fields, each field corresponding to a column in the table; and
a blank input row adjacent to the table, the input row having sections corresponding to the columns of the table, each section providing a work area to enter filter criteria such that when a filtering function is executed on the table, the table displays items filtered in accordance with the filter criteria.

25. Computer-readable medium with program instructions stored thereon that when executed perform the following functions for providing display information on a display device of a computer system:
displays a first view on the display device, the first view comprising a plurality of objects in a table of rows and columns, each object displayed as a row in the table and comprised of a plurality of fields, each field being in a column of the table;
displays a blank input row corresponding to the table, the input row having input fields corresponding to the columns of the table;
receives an input in the form of a character string in a selected input field of the input row;
receives a filter command; and
performs, in response to the filter command, a filtering function on a field of the objects corresponding to the selected input field of the input row using the character string, and displaying filtered data.

26. The medium of claim 25 further comprising, instructions that when executed display, on the display device, a third view that comprises a subset of objects, specified by the filtering function, from the plurality of objects.

27. The medium of claim 26 wherein the third view comprises, from the objects displayed in the first view, only those objects contained in the subset of objects.

28. The medium of claim 26 wherein the subset of objects is arranged in a filtered table of rows and columns with one object per row.

29. The medium of claim 28 further comprising, instructions that when executed display the input row with the filtered table.

30. The medium of claim 29 further comprising, instructions that when executed perform a subsequent filtering function on the filtered table.

31. The medium of claim 26 wherein the third view contains a notification message that a filtering function has been performed.

32. The medium of claim 25 wherein the input row is the first row of the table.

33. The medium of claim 25 wherein the input row comprises a filter row.

34. The medium of claim 25 wherein the objects are database objects.

35. The medium of claim 25 wherein the filter command comprises a carriage return.

36. The medium of claim 25 wherein the filter command comprises a selection of a filter button.

37. The medium of claim 36 wherein the filter button is located in the input row.

38. The medium of claim 25 wherein the filter command comprises the provision of data followed by a predetermined period of inactivity.

39. The medium of claim 25 wherein the input row has an input field for each column of the table.

40. The medium of claim 25 further comprising, instructions that when executed receive input in the form of a plurality of filter conditions, each filter condition comprised of a character string and a corresponding selected field of the input row, before receiving the filter command.

41. The medium of claim 40 further comprising, instructions that when executed apply a logical “AND” relation to the filter conditions.

42. The medium of claim 40 further comprising, instructions that when executed apply a logical “OR” relation to the filter conditions.

43. The medium of claim 26 wherein the filtering function specifies the subset of objects by comparing the character string in the selected input field of the input row with the entry in the corresponding field for each of the objects in the plurality of objects.

44. The medium of claim 25 wherein the character string comprises an operator.

45. The medium of claim 44 wherein the operator is selected from a group consisting of “logical or”, “greater than”, “less than”, “not equal”, range indicator, and wild card indicator

46. The medium of claim 25 wherein the objects are local to a computer system.

47. The medium of claim 25 wherein the input row is associated with a computer application, and is displayed each time the computer application is executed.
